(19) United States
(12) Patent Application Publication
(10) Pub. No.: US 2012/0210617 A1
(43) Pub. Date: Aug. 23, 2012

(54) Display device

(76) Inventor: Rahul Saggar, Brooklyn, NY (US)

(21) Appl. No.: 13/401,805

(22) Filed: Feb. 21, 2012

Related U.S. Application Data
(60) Provisional application No. 61/463,780, filed on Feb. 19, 2011.

(51) Int. Cl. G09F 21/04; F03B 11/02

(52) U.S. Cl. 40/591; 137/561 R

(57) ABSTRACT

The invention is a display device installed on a transporting vehicle. The display device encloses a substance that moves with the inertial “forces” created by the transporting vehicle. The display device can be made up of transparent, translucent, or opaque material. The enclosed material can be gas, liquid, or solid, such as liquid, air, ball bearings, coins, and/or marbles. The device can be installed on the interior (such as ceiling, wall, floor, handles, seats), exterior, or a through structure (such as a window like structure). The vehicle is a device meant to move people or things, such as a train, bus, car, elevator, bike, airplane, gondola, ship, boat, or truck. The device is meant to be observed visually and/or sonically. The device is meant to be used for entertainment, advertising, and/or energy extraction.

Existing art is a machine or manufacture with or without an encased flow-able material. The flow-able material is typically caused to move through some energy imparted by the said machine or manufacture. The device applied for uses an independent vehicle to apply energy to move encased material or materials.

### DESCRIPTION OF DRAWINGS

FIG. 1 is a section of a generic public transportation vehicle, such as a bus or train. 1 and 2 show a window and seat, respectively. Locations of FIGS. 2 to 5 are shown. 2A denotes another location where the device can be installed. The surface in 2A is neither perpendicular nor parallel to the floor.

FIG. 2 is a detail (enlarged scale) section of one embodiment of the device, 3, installed on the ceiling as located in FIG. 1. This embodiment can be installed in other locations as previously discussed. Location of FIG. 7 is shown.

FIG. 3 shows a detail (enlarged section) of a handle, 12, located in FIG. 1. The handle can be made of a material that can provide a chamber, 13, that can be filled with a flow-able material, such as liquid, air, ball bearings, coins, and/or marbles as previously discussed.

FIG. 4 exhibits a detail (enlarged section) of another embodiment of the device installed in a possible location on the exterior of the vehicle, as shown in FIG. 1. 9 is a light bulb, such as an LED or an incandescent bulb. 8 is a conductive fluid, such as mercury, or an ionic solution, that closes the circuit to allow for lighting the bulbs 9.

FIG. 5 exhibits a detail (enlarged section) of another embodiment of the device installed in a possible location on the interior of the vehicle, as show in FIG. 1. 10 is the device with a solid material, 11, such as a disc (like a coin) enclosed.

FIG. 6 shows a further detail (enlarged scale) section of one embodiment of the device. 4 is a method of attachment of the device, such as double sided tape, or an adhesive. Fasteners or other means of attachment are also possible. 5 show the encased material. In this case liquid is encased, however other materials, as previously discussed, can be encased. 6 shows the encasement material that is a solid that can be transparent, translucent, or opaque as previously discussed. 7 is a closure piece which also provides the space for the encased material to move in.

FIG. 7 shows a photograph of one embodiment of the device with a colored water solution encased in clear acrylic and installed on the ceiling during a test installation.

### VARIATIONS

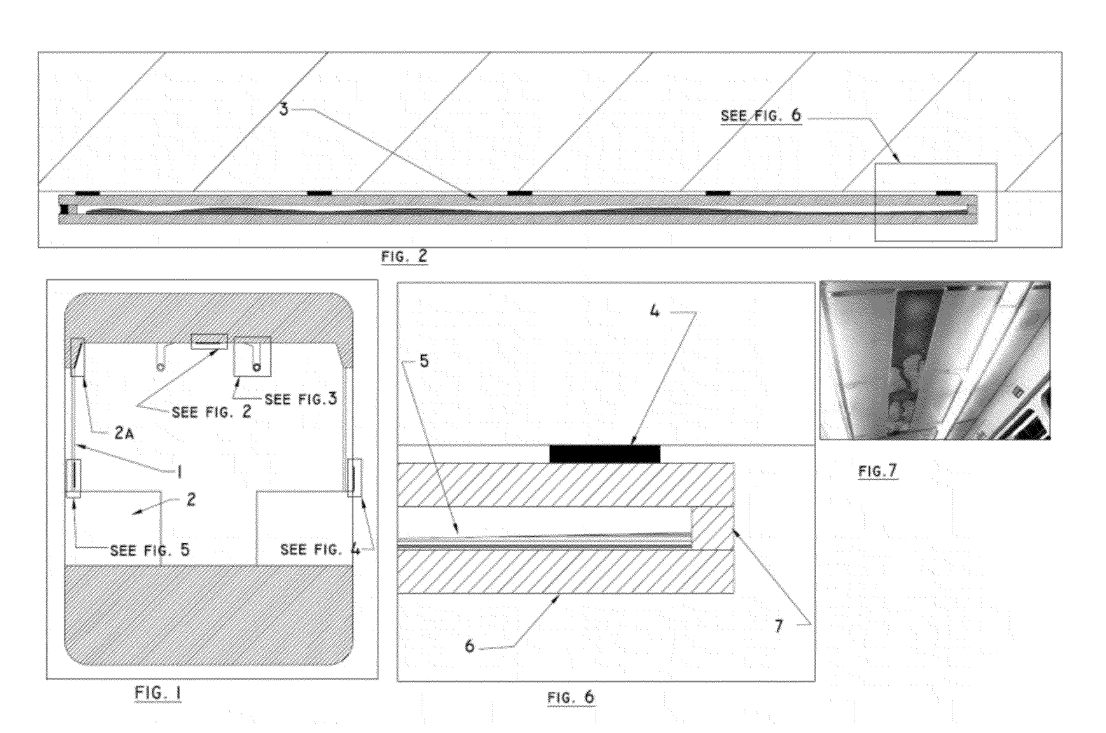

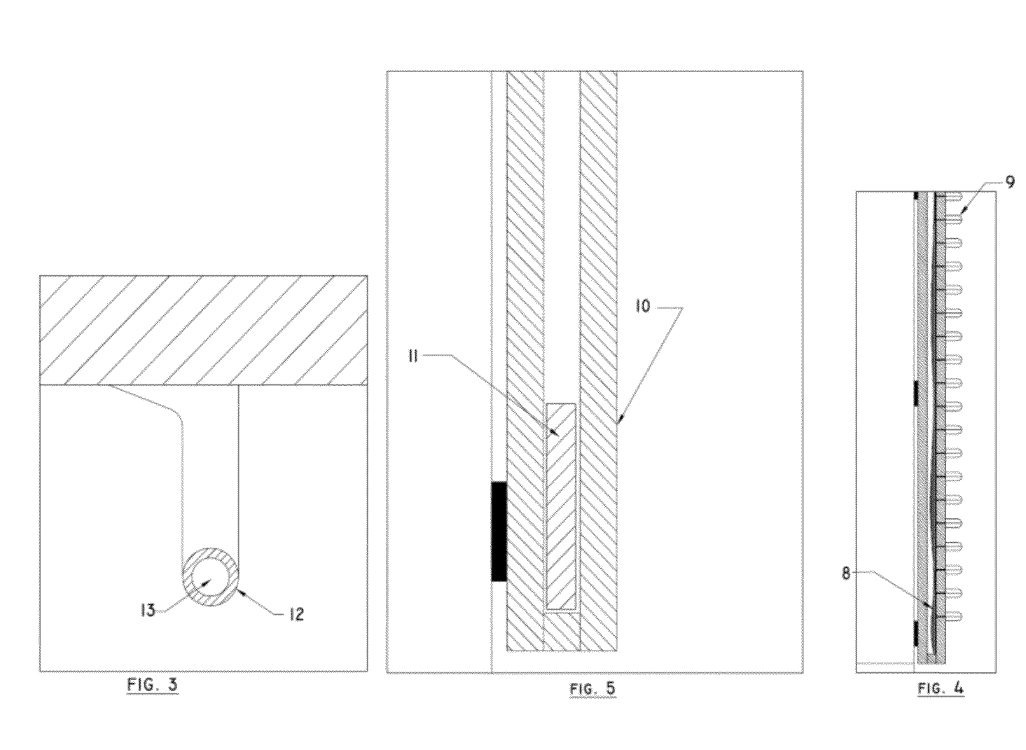

In addition to the variations mentioned above, the system can be varied such that: Embodiments shown can be interchanged, meaning the conductive fluid/light embodiment shown in FIG. 4 can be installed in locations shown in FIG. 5, or the fluid embodiment shown in FIG. 2 can be installed in the location of FIG. 4. Although the embodiments shown are angular the configuration can be such that there is a more organic shape that disperses like vines or veins.

1. A device meant to encase flow-able material that moves from the inertia forces imparted from the vehicle it is installed on.

2. Device in claim 1 used, to transmit visibly or sonically the movement of the encased material.

3. (canceled)

4. (canceled)

5. Device in claim 1 used to advertise or entertain.

6. Device in claim 2 used to advertise or entertain,

7. Device used in claim 1 to extract energy.

8. Device used in claim 2 to extract energy.
